(19) United States
(12) Patent Application Publication
(10) Pub. No.: US 2023/0158479 A1
(43) Pub. Date: May 25, 2023

(54) CATALYST FOR THE GENERATION OF HYDROGEN AND/OR SYNTHESIS GAS, METHOD FOR OBTAINING SAME AND USE IN A STEAM REFORMING PROCESS

(71) Applicants: Petróleo Brasileiro S.A. - Petrobras, Rio de Janeiro (BR); Universidade Federal Do Rio De Janeiro - UFRJ, Rio de Janeiro (BR)

(72) Inventors: Renato Dias Barbosa, Cachoeira Paulista (BR); Roberto Carlos Pontes Bittencourt, Rio de Janeiro (BR); Fabio Menezes Passarelli, Rio de Janeiro (BR); Victor Luis Dos SantosTeixeira Da Silva, Petrópolis (BR); Antonio Marcos Fonseca Bidart, Rio de Janeiro (BR); Juliana Pereira Silva, Rio de Janeiro (BR)

(73) Assignees: Petróleo Brasileiro S.A. ? Petrobras, Rio de Janeiro, RJ (BR); Universidade Federal Do Rio De Janeiro - UFRJ, Rio de Janeiro, RJ (BR); Universidade Federal Do Rio De Janeiro - UFRJ, Rio de Janeiro, RJ (BR)

(21) Appl. No.: 17/916,256

(22) PCT Filed: Mar. 25, 2021
(86) PCT No.: PCT/BR2021/050126

§ 371 Date: Sep. 30, 2022

(30) Foreign Application Priority Data
Apr. 3, 2020 (BR) BR 10 2020 006833

(51) Int. Cl. B01J 23/89; B01J 21/10; B01J 37/08; C01B 3/40; B01J 35/10; B01J 6/00; B01J 37/03; B01J 37/04

(52) U.S. Cl. CPC B01J 23/8993; B01J 21/10; B01J 37/08; C01B 3/40; B01J 35/1019; B01J 35/1014; B01J 6/001; B01J 37/031; B01J 37/04; C01B 2203/0233; C01B 2203/1082; C01B 2203/1058

(57) ABSTRACT

The present invention addresses to a catalyst, and the method for obtaining the same, for generating hydrogen and/or syngas. More specifically, the present invention describes a catalyst based on nickel, molybdenum and tungsten, for steam reforming processes of natural gas or other hydrocarbon streams (refinery gas, propane, butane, naphtha or any mixture thereof) that presents high resistance to deactivation by coke deposition. According to the present invention, the catalyst has NiMoW as its active phase, in bulk form and/or supported on an alumina oxide and other high surface area oxide supports, and may also contain other promoters. Furthermore, the present invention teaches the production of a catalyst whose active phase of NiMoW has high activity for hydrocarbon steam reforming reaction.

### FIELD OF THE INVENTION

The present invention addresses to a catalyst, and the method for obtaining the same, for the generation of hydrogen and/or syngas from the steam reforming of hydrocarbons.

More specifically, the present invention describes a catalyst based on nickel, molybdenum and tungsten, for steam reforming processes of natural gas or other hydrocarbon streams (refinery gas, propane, butane, naphtha or any mixture thereof), which has high resistance to deactivation by coke deposition. The active phase composed of nickel, molybdenum and tungsten also provides a high catalytic activity for the reforming reactions, prolonging the campaign time of the hydrogen generation units and reducing the cost of producing hydrogen and syngas.

### DESCRIPTION OF THE STATE OF THE ART

Steam catalytic reforming is the main industrial process for converting natural gas and other hydrocarbons into syngas and hydrogen. This process has been extensively studied in order to obtain hydrogen for refining processes and syngas for the production of synthetic fuels (GTL), methanol, ammonia, urea and other products of petrochemical interest (Tao, Y., “Recent Advances in Hydrogen Production Via Autothermal Reforming Process (ATR)”: A Review of Patents and Research Articles Recent Patents on Chemical Engineering, v. 6, pp. 8-42, 2013; and Li, D.; Tomishige, K. “Methane reforming to syngas over Ni catalysts modified with noble metals”, Applied Catalysis A: General, v. 408, pp. 1-24, November 2011).

Hydrogen and gases rich in hydrogen and carbon monoxide, known as syngas, are currently produced industrially, mainly by the steam reforming process of methane or naphtha. The main reactions that occur in the steam reforming process are presented below (reactions 1, 2 and 3):

CnHm+nH₂O=nCO+(n+½m)H₂ (endothermic Reaction 1 reaction)

CH₄+H₂O=CO+3H₂ (endothermic, 206.4 kJ/mol) Reaction 2

CO+H₂O=CO₂+H₂ (exothermic, −41.2 kJ/mol) Reaction 3

The steam reforming process can have different configurations, depending on the type of charge and the desired use for the hydrogen-rich gas to be produced. Steam reforming is usually carried out by introducing the previously purified hydrocarbon (charge) and steam into reforming reactors. Such reactors comprise metallic tubes, with typical dimensions of 7 cm to 15 cm of external diameter and height in the range of 10 meters to 13 meters, located inside a heating furnace, which supplies the necessary heat for the reactions. The set formed by the metallic tubes and the furnace is called the primary reformer.

The typical charge inlet temperature in the primary reformer is in the range of 400° C. to 550° C., and the output temperature, in the range of 750° C. to 950° C., at typical pressures from 10 kgf/cm² (0.981 MPa) to 35 kgf/cm² (3.432 MPa). These severe conditions require the use of special metal alloys for making the tubes. Due to their high price, reformers account for a considerable fraction of the fixed costs of the process.

The catalysts used in steam reforming must have features such as high activity, reasonably long lifetime, good heat transfer, low pressure drop, high thermal stability and excellent mechanical strength. The activity of steam reforming catalysts can be defined by parameters known in the industry, such as the approach temperature, the effluent methane content of the primary reformer and the wall temperature of the reformer tubes (Rostrup-Nielsen, J. R. “Catalytic Steam Reforming”, Spring-Verlag, 1984).

Among the main problems that lead to the reduction of the activity of the nickel-based catalyst on refractory supports, the deposition of carbon (coke) stands out (Rostrup-Nielsen, J. R. “Coking on nickel catalysts for steam reforming of hydrocarbon”, Journal of Catalysis, v. 33, pp. 184-201, 1974, and Borowiecki, T. “Nickel catalysts for steam reforming of hydrocarbons: direct and indirect factors affecting the coking rate”, Applied Catalysis, v. 31, pp. 207-220, 1987); poisoning by sulfur compounds (Rostrup-Nielsen, J. R. “Catalytic Steam Reforming”, Spring-Verlag, 1984); chloride contamination and deactivation by exposure to elevated temperatures (sintering) (Sehested, J.; Carlsson, A.; Janssens, T. V. W.; Hansen, P. L.; Datye, A. K. “Sintering of Nickel Steam-Reforming Catalysts on MgAl2O4 Spinel Supports”, Journal of Catalysis, v. 197, pp. 200-209, January 2001; and Sehested, J.; Gelten, J. A. P.; Remediakis, I. N.; Bengaard, H.; Norskov, J. K. “Sintering of nickel steam-reforming catalysts: effects of temperature and steam and hydrogen pressures”, Journal of Catalysis, v. 223, pp. 432-443, April 2004). Less well known in the literature is the negative effect on the activity of the catalyst caused by a low degree of reduction of the nickel oxide species present in the same. Usually, the catalysts used industrially in the steam reforming process are made up of nickel oxide species deposited on a low surface area refractory support, generally less than 10 m²/g. Such species need to be reduced to metallic nickel so that the catalyst presents activity of converting hydrocarbons to hydrogen. Usually, this reduction step is carried out in the reactor itself, using reducing agents selected from hydrogen, ammonia, methanol, and natural gas, in the presence of a substantial excess of steam. A low degree of reduction of the present nickel oxide species to metallic nickel compromises the catalyst activity. This situation is more critical at the top of the reactors, where the temperature is lower, as it is known that low temperatures make it difficult to reduce nickel oxide species to metallic nickel (Kim, P.; Kim, Y.; Kim, H.; Song, I. K.; Yi, J. “Synthesis and characterization of mesoporous alumina with nickel incorporated for use in the partial oxidation of methane into syngas”, Applied Catalysis A: General, v. 272, pp. 157-166, September 2004).

The literature teaches that certain features of the supported nickel catalyst influence its reduction rate, such as the nickel content present (Kim, P.; Kim, Y.; Kim, H.; Song, I. K.; Yi, J. “Synthesis and characterization of mesoporous alumina with nickel incorporated for use in the partial oxidation of methane into syngas”, Applied Catalysis A: General, v. 272, pp. 157-166, September 2004); the temperature used in the calcination step during its manufacturing process (Teixeira, A. C. S. C.; Giudici, R. “Deactivation of steam reforming catalysts by sintering: experiments and simulation”, Chemical Engineering Science, v. 54, pp. 3609-3618, July 1999) and the type of refractory support used. A tendency usually found in the literature is to attribute to steam reforming catalysts that use magnesium aluminate or calcium aluminate supports the ability to promote the reduction of nickel oxide species to metallic nickel at higher temperatures than those based on alpha-alumina.

Although they present a greater difficulty to undergo reduction, steam reforming catalysts that use supports with a basic character, such as magnesium aluminate or calcium aluminate, for example, are recommended for processing charges that have a greater tendency to form. of coke, such as naphtha or natural gas containing hydrocarbons with chains longer than C4. The literature suggests that it would be desirable to use supports with a high surface area for the preparation of steam reforming catalysts, which theoretically allow obtaining a greater degree of dispersion of the active phase (metallic nickel), with a consequent increase in the activity steam reforming.

Patent application PI1000656-7 teaches the preparation of a nickel-type steam reforming catalyst supported on magnesium aluminates promoted by an alkali metal, particularly potassium, with greater resistance to coke deactivation and greater activity than materials in accordance with the state of the art.

Patent documents WO 91113831 and U.S. Pat. No. 4,880,757 teach the preparation of high surface area magnesium aluminates by adding promoters such as zirconium oxide in their formulation. In practice, however, it is observed that the activity of nickel-based steam reforming catalysts on high surface area supports is lower than expected and even lower than that of similar catalysts on low surface area supports.

The literature teaches that cerium has been widely used as a support and/or catalyst for catalysts in the steam reforming reaction of methane, as it has satisfactory thermal resistance and mechanical strength and also a high oxygen storage capacity (Purnomo, A.; Gallardo, S.; Abella, L., Salim, C., Hinode, H. “Effect of ceria loading on the carbon formation during low temperature methane steam reforming over a Ni/CeO₂/ZrO₂ catalyst”, React Kinet Catal Lett, v. 95, pp. 213-220, 2008; and Andreeva, D.; Idakiev, V.; Tabakova, T.; Ilieva, L.; Falaras, P.; Bourlinhos, A.; Travlos, A. “Low-temperature water-gas shift reaction over Au/CeO₂ catalysts”, Catalysis Today, v. 72, pp. 51-57, February 2002). This last feature significantly contributes to the removal, by oxidation, of carbonaceous precursors formed on the surface of the support. When the catalyst is in its reduced state, oxygen vacancies are present on the cerium surface. Even if oxygen is not present in the gas phase, water and/or CO₂ formed can serve as an oxidizing medium. H₂O and/or CO₂ molecules dissociate on the surface of the material and the atomic oxygen formed reoxidizes cerium. The high number of vacancies facilitates the mobility of atomic oxygen, which can also act as an oxidant of carbonaceous deposits (Sekini, Y.; Haraguchi, M.; Matsukata, M.; Kikuchi, E. “Low temperature steam reforming of methane over metal catalyst supported on CeₓZr₁₋ₓO₂ in an electric field”, Catalysis Today, v. 171, pp. 116-125, August 2011; Koo, K. Y.; Roh, H. S.; Seo, D. J.; Yonn, W. L.; Bin, S. “Coke study on MgO-promoted Ni/Al₂O₃ catalyst in combined H₂O and CO₂ reforming of methane for gas to liquid (GTL) process”, Applied Catalysis A General, v. 340, pp. 183-190, June 2008; and Vagia, E. C.; Lemonidou, A. A. “Investigations on the properties of ceria-zirconia-supported Ni and Rh catalysts and their performance in acetic acid steam reforming”, Journal of Catalysis, v. 269 (2010), pp. 388-396, February 2010).

Studies involving the modification of the Al₂O₃ support with CeO₂ and La₂O₃ showed that the addition of CeO₂ and La₂O₃ in a catalyst containing 7% (m/m) Ni/Al₂O₃ altered the morphological characteristics of the catalyst, leading to an increase in the specific area and dispersion of nickel, consequently improving the catalytic properties. The addition of 6% (m/m) cerium to the 7% (m/m) Ni/Al₂O₃ catalyst led to an increase of approximately 10% in methane conversion at 550° C. (methane conversion without cerium=70%, methane conversion with cerium=82%). The 7% (m/m) Ni/Al₂O₃ catalyst promoted with 6% (m/m) of La₂O₃ reached almost the same conversion at 550° C. obtained for the material without the addition of promoters (methane conversion with catalyst promoted with lanthanum=74%) (Dan, M. et al.; “Supported nickel catalysts for low temperature methane steam reforming: Comparison between metal additives and support modification”, Reaction Kinetics Mechanisms and Catalysis, v. 105, pp. 173-193, February 2012).

According to the literature (Liu, C. J.; Ye, J.; Jiang, J.; Pan, Y. “Progresses in the Preparation of Coke Resistant Ni-based Catalyst for Steam and CO₂ Reforming of Methane”, Chem Cat Chem, v. 3, pp. 529-541, February 2011), the key point for the development of coke-resistant Ni catalysts is the crystallite size control. It is worth to emphasize that the use of CeO₂ and ZrO₂, both as promoters and supports, has an advantage in terms of increasing activity and, even more importantly, in reducing the tendency to form coke.

Document PI0903348-3 teaches that the low activity of nickel catalysts on high surface area supports arises from the greater difficulty in reducing nickel oxide species to metallic nickel. This phenomenon was observed especially in industrial conditions, where there is a large excess of steam during the reduction step, which can be explained by the greater interaction of nickel oxide species with high surface area supports (Bittencourt, R. C. P, Cavalcante, R. M., Silva, M. R. G., Fonseca, D. L., Correa, A. A. L. “Avaliação comparativa entre gama-alumina e alfa-alumina como suporte de catalisadores de reforma a vapor pela técnica de TPR na presença de vapor”—14^{th} Brazilian Congress of Catalysis, 2007 and Bittencourt, R. C. P., Correa, A. A. L., Fonseca, D. L., Mello, G. C., Silva, M. R. G., Nascimento, T. L. P. M., “Caracterização por redução a temperatura programada (TPR) de catalisadores de reforma a vapor—aplicação em condições industriais”—15^{th} Brazilian Congress of Catalysis, 2009). Clearly, from an industrial application point of view, there is desirable a method for increasing the degree of reduction of nickel oxide species on high surface area supports, especially high surface area supports of theta-alumina type, calcium aluminates, magnesium aluminates and mixtures. A technically possible method to minimize the problems associated with the difficulty of reducing the catalyst under industrial conditions of the primary reformer would be its pre-reduction, that is, subjecting the catalyst during its production phase to reduction procedures and then a passivation to allow safe transport without the risk of flammability. With the adoption of pre-reduction procedures, it is possible to obtain a significant content of nickel that is easily reducible under the industrial conditions practiced in the primary reformer, especially in the top section of the tubes, where the temperature is lower. However, although technically possible, in case there are commercial pre-reduced steam reforming catalysts, the adoption of this type of procedure would imply an increase in the fixed investment to have adequate installations and which would lead to an increase in the cost of the final product.

From the point of view of preparing steam reforming catalysts, it would be highly desirable to have a practical method of controlling the degree of nickel reduction that could be applied to different supports, particularly supports with high surface area. The literature teaches the use of a second metal in the formulation of supported nickel-type catalysts for the production of hydrogen and/or syngas in partial oxidation processes.

In the patent document U.S. Pat. No. 7,223,354, for example, the invention of a catalyst for the production of syngas by the partial oxidation of light hydrocarbons is reported, which uses a catalyst based on nickel in solid solution, with magnesium oxide promoted by at least one promoter chosen from the group of Cr, Mn, Mo, W, Sn, Re, Rh, Ru, Ir, La, Ce, Sm, Yb, Lu, Bi, Sb, In, and P.

The literature teaches the use of Pt group metals in steam reforming catalyst formulations, as an active metal or as an activity promoter (Wei, J., Iglesia, E. “Reaction Pathways and Site Requirements for the Activation and Chemical Conversion of Methane on Ru-Based Catalysts”, Journal Physical Chemistry B, v. 108, pp. 7253-7262, April 2004; Rostrupnielsen, J. R.; Hansen, J. H. B. “CO₂-Reforming of Methane over Transition Metals”, Journal of Catalyst, v. 144, pp. 38-49, November 1993; Wei, J., Iglesia, E. “Structural requirements and reaction pathways in methane activation and chemical conversion catalyzed by rhodium”, Journal of Catalysis, v. 225, pp. 116-127, July 2004; and Wei, J.; Iglesia, E. “Isotopic and kinetic assessment of the mechanism of methane reforming and decomposition reactions on supported iridium catalysts”, Physical Chemistry Chemical Physics, v. 6, pp. 3754-3759, 2004; Nitz, M., et al. “Structural Origin of the High Affinity of a Chemically Evolved Lanthanide-Binding Peptide”, Chemie International Edition, v. 43, pp. 3682-3685, July 2004; and Wei, J.; Iglesia, E. “Mechanism and Site Requirements for Activation and Chemical Conversion of Methane on Supported Pt Clusters and Turnover Rate Comparisons among Noble Metals”, Journal of Physical Chemistry B, v. 108 pp. 4094-4103, March 2004). However, the catalysts produced with Pt group metals are much more expensive than those prepared with nickel, although they have a lower tendency to form carbon.

Patent document EP 1,338,335 describes a steam reforming catalyst consisting of cobalt or nickel, in contents between 01% and 20% w/w, a component selected from the group of Pt, Pd, Ru, Rh and Ir, with contents between 01% and 8% w/w, on a support composed of alumina oxide and cerium oxide.

In US patent document 4,998,661, a steam reforming catalyst is described containing at least one metal oxide selected from nickel oxide, cobalt oxide or platinum oxide on supports composed of alumina and oxides selected from the group of Ca, Ba or Mr.

In the patent document U.S. Pat. No. 7,309,480, a steam reforming catalyst is described consisting of at least one active metal, selected from the group of Pt, Pd or Ir on a support. However, no mention is made of the use of metallic promoters to increase the rate of reduction of the catalyst nickel oxide species.

The literature teaches the effect of using metallic promoters for nickel-type steam reforming catalysts on refractory supports, in order to reduce the coke content.

In the patent document U.S. Pat. No. 4,060,498, the use of silver is described, in levels of at least 2 mg per 100 grams of the nickel-based catalyst, as a promoter to reduce the formation of coke.

In US patent document 5,599,517, the use of a metal selected from the group consisting of Ge, Sn, and Pb is described, with contents between 1% and 5%; 0.5% and 3.5% and 0.5% and 1% (w/w), respectively, in nickel-based catalyst, as a promoter to reduce coke formation. In both patents, the metal is added as a promoter to reduce the rate of coke formation, with the undesirable effect of reducing the activity of the catalyst.

The patent document WO 2007/015620 describes the use of a nickel-based steam reforming catalyst, impregnated with Ru or Pt, at levels from 0.001% to 1.0% w/w, capable of showing activity steam reforming in the temperature range of 380° C. to 400° C., without the pre-reduction step. According to this invention, the catalyst for use in fuel cells in small hydrogen production stations, which are subjected to frequent stop and start cycles, has the advantage of dispensing with the use of auxiliary equipment for the supply of a reducing agent, such as hydrogen or ammonia.

Considering the high price of noble metals, such as Ru and Pt, for their use in steam reforming catalysts to be commercially successful, it is necessary to reduce their use only to what is strictly necessary, especially in large units that use high volumes of catalysts. In large steam reforming units, the need to use promoters to increase the reduction rate of the nickel oxide phases occurs only in the reactor inlet region, which is the lowest temperature region. A distinction must further be made between the reduction procedure of a steam reforming catalyst that uses natural gas (or propane or butane) from a catalyst that uses naphtha as a raw material. According to industrial practice and the recommendations of commercial catalyst manufacturers, it is mandatory to carry out a reduction step, with the addition of a reducing agent—which can be natural gas, hydrogen, ammonia or methanol—before introducing the naphtha feed to the reactor. This reduction step is carried out in the presence of a large excess of steam, and its objective is to prevent the catalyst from being rendered useless by a rapid and excessive formation of coke, which would occur by the direct feeding of steam and naphtha over a non-reduced catalyst. In this way, industrial steam reforming units that use naphtha as a raw material have equipment and conditions for the previous and mandatory step of catalyst reduction. The literature also teaches that the addition of noble metals to supported nickel oxide-based catalysts favors the reduction of nickel oxide species to metallic nickel using dry H₂ as the reducing agent (Nowak, E. J.; Koros, R. M. “Activation of supported nickel oxide by platinum and palladium”, Journal of Catalysis, v. 7, pp. 50-56, January 1967; and Li, X.; Chang, J. S., Park, S. E. “CO₂ reforming of methane over zirconia-supported nickel catalysts, I. Catalytic specificity”, Reaction Kinetics Catalysis Letters, v. 67, pp. 375-381, July 1999).

The literature also teaches that the presence of steam hinders the reduction of supported nickel oxide (Richardson, J. T.; Lei, M.; Turk, B.; Forster, K.; Twigg, V. “Reduction of model steam reforming catalysts: NiO/α-Al₂O₃”, Applied Catalysis A: General, v. 10, pp. 217-237, March 1994, and Zielinski, J. “Effect of water on the reduction of nickel/alumina catalysts Catalyst characterization by temperature-programmed reduction”, Journal of Chemical Society, Farady Transactions, v. 93, pp. 3577-3580, 1997).

Document PI0903348-3 teaches that a low noble metal content is able to eliminate the negative effects of water vapor on the reduction rate of nickel oxide species, particularly when using high surface area supports.

Thus, although there are several citations and descriptions in the specialized literature of processes involving the use of a second metal in the preparation of nickel-based steam reforming catalysts on refractory supports, these processes do not characterize the use of a second metal to accelerate the rate of reduction of nickel oxide species in the presence of water vapor and with catalysts prepared using high surface area supports. Additionally, document PI0903348-3 teaches the use of the promoted catalyst only in low temperature regions of the steam reforming process reactors, more particularly, in the upper section of the reactor, preferably at a depth of up to 30% from the top of the primary reformer, and that can be applied to a wide range of raw materials fed to the process and types of supports used to prepare the catalysts.

The literature also teaches the use of gold, as a promoter in Ni/MgAl₂O₄ and Ni/Al₂O₃ catalysts, to increase the resistance to coke deactivation (Dan, M. et al. “Supported nickel catalysts for low temperature methane steam reforming: Comparison between metal additives and support modification”, Reaction Kinetics Mechanisms and Catalysis, v. 105, pp. 173-193, February 2012; and Chin, Y. H. et al. “Structure and reactivity investigations on supported bimetallic Au—Ni catalysts used for hydrocarbon steam reforming”, Journal of Catalysis, v. 244, pp. 153-162, December 2006). According to the literature, binary Ni—Au systems do not form a massive alloy, they only form a surface alloy. In this alloy, gold blocks the sites that are responsible for carbon formation (Chin, Y. H. et al. “Structure and reactivity investigations on supported bimetallic Au—Ni catalysts used for hydrocarbon steam reforming”, Journal of Catalysis, v. 244, pp. 153-162, December 2006). The Ni—Au/Al₂O₃ catalyst showed a 10% increase in CH₄ conversion (X=85%) when compared to the Ni/Al₂O₃ catalyst (X=75%) in the steam reforming reaction at 550° C. The reaction rate per active site (turnover frequency—TOF) for the Au promoted catalyst showed a slightly higher value when compared to that obtained for Ni/Al₂O₃ catalysts (Dan, M. et al. “Supported nickel catalysts for low temperature methane steam reforming: Comparison between metal additives and support modification”, Reaction Kinetics Mechanisms and Catalysis, v. 105, pp. 173-193, February 2012). The literature teaches the use of La, Rh and B as promoters to improve dispersion and increase resistance to coke formation in a Ni/MgAl₂O₄ catalyst (Ligthart, D. A. J. M.; Pieterse, J. A. Z.; Hensen, E. J. M. “The role of promoters for Ni catalysts in low temperature (membrane) steam methane reforming”, Applied Catalysis A General, v. 405, pp. 108-119, October 2011). Lanthanum was selected as a promoter because it improves metal dispersion and prevents coke formation. Boron, on the other hand, inhibits carbon diffusion in the bulk. Rhodium was chosen because of its resistance to coke formation and high activity in steam reforming of methane.

Regarding the formation of coke, the literature teaches the use of additives such as Sn, Sb, Bi, Ag, Zn and Pb, in concentrations in the range of 1 to 2% (m/m), in nickel-based catalysts. The addition of these metals contributed to the reduction of coke deposition and the proposed inhibition mechanism was based on the hypothesis that the interaction of the p or d electronic levels of these metals with the 3d electrons can prevent the formation of carbon (2p)-nickel (3d) bonds responsible for the formation of nickel carbide (coke precursor). The best ratio between steam reforming and coke formation rate was obtained when 1.75% (m/m) of Sn was added. The Sn-promoted catalyst showed much higher activity and a lower rate of coke formation when compared to the unpromoted Ni catalyst under similar reaction conditions (Trimm, D. L. “Catalysts for the control of coking during steam reforming”, Catalysis Today, v. 49, pp. 3-10, February 1999).

It is also taught in the literature the use of nickel/α-alumina catalysts promoted by oxides of Mo (0.5%), W (2.0%), Ba (2.0%), K (1.0%), and Ce (0.2%, 0.5%, 1.0%, and 2.0%) for the n-butane steam reforming reaction. It was observed that the catalysts with cerium presented an increase in the metallic area and in the activity when compared to the catalyst without promoter. In the case of catalysts promoted with the other metals, there was a decrease both in the metallic area and in the activity. Regarding the tendency to coke formation, the catalysts promoted with K, Ba, Mo, and W showed a slower deactivation process than the catalysts promoted with Ce and without promoter. Regarding resistance to coke deactivation, the best results were obtained with the addition of 0.5% of WO₃ or MoO₃ (Armor, J. N., “The Multiple Roles for Catalysis in the Production of H₂”, Applied Catalysis A: General, v. 21, pp. 159-176, 1999; Barelli, L.; Bidini, G.; Corradetti, A.; Desideri, U. “Production of hydrogen through the carbonation-calcination reaction applied to CH₄/CO₂ mixtures”, Energy, v. 32, pp. 834-843, May 2007; Borowiecki, T; Golebiowski, A.; Ryczkowski, J.; Stasinska, B. “The influence of promoters on the coking rate of nickel catalysts in the steam reforming of hydrocarbons”, Studies in Surface Science and Catalysis, v. 119, pp. 711, 1998; and Borowiecki, T.; Golcebiowski, A. “Influence of molybdenum and tungsten additives on the properties of nickel steam reforming catalysts”, Catalysis Letters, v. 25, pp. 309-313, September 1994).

The use of Ni/Al₂O₃ catalysts promoted with up to 2% molybdenum for methane steam reforming reaction is also taught in the literature (Maluf, S. S; Assaf, E. M. “Ni catalysts with Mo promoter for methane steam reforming”, Fuel, v. 88, pp. 1547-1553, September 2009). The reactions conducted with steam/carbon ratios equal to 4 showed that all prepared catalysts (0.00%, 0.05%, 0.5%, 1.0%, and 2.0% molybdenum) showed high activity and stability. However, when the vapor/carbon ratio was reduced to 2.0, catalysts containing 0.00%, 0.5%, 1.0%, and 2.0% molybdenum showed deactivation after approximately 400 minutes of reaction, having only the catalyst promoted with 0.05% molybdenum showed stability to coke formation for a long period of time (more than 30 hours of reaction). In the case of catalyst containing 0.05% Mo, the explanation for the presented behavior is related to the possible occurrence of an electronic interaction between the molybdenum and nickel species. In this case, the MoOₓ species transfer electrons to metallic Ni. This effect would lead to an increase in the electron density of Ni sites, decreasing the number of available sites, but making them more active. Thus, the methane dehydrogenation reaction would occur in a smaller proportion, leading to a lower carbon production. In this case, the smaller amount of carbon formed in the form of filaments would be more easily gasified. Higher levels of molybdenum could cause the blocking of active Ni sites by MoOₓ species, which would lead to the formation of “clusters” on the catalyst surface, which would reduce the electron transfer efficiency.

As seen above, the possibility of using nickel with other metals, especially noble metals, has been widely studied in order to increase activity, resistance to carbon formation and also allow using the same catalyst for different charges of the steam reforming process. However, even with the function of promoters (use in very small amounts), the use of noble metals, such as Ru and Pt, in formulations of steam reforming catalysts has a direct impact on hydrogen and/or hydrogen production costs. syngas. Thus, the search for catalysts with lower production costs, high hydrothermal stability and high resistance to coke formation is still a challenge to be overcome. Nonetheless, for non-noble metal catalysts, deactivation and carbon deposition have become the main obstacles to the development of new materials.

In this context, the present invention teaches a new steam reforming catalyst, based on an active system of the NiMoW type, in bulk form or supported on an alumina oxide and other oxide supports, with high resistance to deactivation by coke. This catalyst has the additional benefit of lower steam consumption as it allows working with a lower steam/carbon ratio, when it is desired to obtain syngas with low H₂/CO ratios for use in petrochemical processes (GTL, methanol, etc.). Additionally, its production cost is lower when compared to catalysts containing noble metals.

The high resistance of the present catalyst to deactivation by the formation of coke, when operating in conditions of low vapor/carbon ratios, may be associated with the formation of molybdenum and tungsten carbides that still maintain a certain ability to promote the reforming reaction via a carburation/oxidation mechanism. This mechanism has been taught in the literature when using these carbides in dry reforming reactions (Zhang, A. et al. “In-situ synthesis of nickel modified molybdenum carbide catalyst for dry reforming of methane”, Catalysis Communications, v. 12, pp. 803-807, April 2011; Shi, C. et al. “Ni-modified Mo₂C catalysts for methane dry reforming”, Applied Catalysis A: General, v. 431-432, pp. 164-170, July 2012; York, A. P. E., Claridge, J. B., Brungs, A. J., Tsang, S. C. and Green, M. L. H. (1997) “Molybdenum and Tungsten Carbides as Catalysts for the Conversion of Methane to Syngas using Stoichiometric Feedstocks”, Chemical Communications, pp. 39-40, 1997). R—Mo₂C was active in dry reforming, steam reforming and partial oxidation of methane to syngas, under conditions of 8 bar (0.8 MPa) pressure and temperatures ranging between 847 and 947° C., without showing carbon deposition on the surface. In the cyclic oxidation/recarburetion mechanism of the carbide, Mo₂C would be responsible for activating CO₂ (CO₂→CO+½O₂) oxidizing (MoOₓ) and nickel (Ni⁰) responsible for decomposing CH₄ (CH₄→C(s)+2H₂); later, the molybdenum oxide would be autothermally recarburized by the carbon deposited on the Ni⁰ sites (Zhang, A. et al. “In-situ synthesis of nickel modified molybdenum carbide catalyst for dry reforming of methane”, Catalysis Communications, v. 12, pp. 803-807, April 2011, and Shi, C. et al., “Ni-modified Mo₂C catalysts for methane dry reforming”, Applied Catalysis A: General, v. 431-432, pp. 164-170, July 2012). In this case, however, for the catalyst to remain active and stable during long campaign periods, it is necessary that the consumption rates of CO₂ and CH₄ are equal.

In this scenario, the present invention teaches the production of a catalyst, whose active NiMoW phase has high activity for hydrocarbon steam reforming reaction, with nickel being the main responsible for the decomposition of methane into H₂ and C(s), and the other metals having a synergistic action on the activity and resistance to coke formation of the catalyst. In this case, when the NiMoW catalyst operates under conditions of low vapor/carbon ratio, the formation of molybdenum and tungsten carbides probably occurs, which still maintain a certain ability to promote the reforming reaction, via the carburization/oxidation mechanism, mitigating, thus, the consequent deactivation by carbon deposition of the nickel active sites. The return of the vapor-carbon ratio to the original level probably ends up promoting the decarburization of the catalyst and increasing its activity for the steam reforming process. Documents WO 2018/117339, WO 00/42119, US 2019/0126254 and BR 1120180156159 teach methods of preparing NiMoW catalysts, used in the sulfide form, for the hydrorefining reaction/process (desulfurization, hydrodenitrogenation, hydrocracking, etc.) streams of oil and derivatives. Hydrotreatment reactions and processes are totally different from steam reforming reactions both from the point of view of the reactants, products, kinetics, thermodynamics and reaction mechanism involved and from the point of view of the process conditions (temperature, pressure, space velocity, among others). No document of the state of the art discloses a NiMoW catalyst with high resistance to coke deactivation for generating hydrogen and/or syngas from the steam reforming of hydrocarbons such as that of the present invention.

In the present invention, in an unprecedented way, the trimetallic form of NiMoWo (not sulfide) is used directly in the process of steam reforming of hydrocarbon streams. In this invention, the trimetallic NiMoW catalyst is prepared via coprecipitation in ammoniacal medium of a mixture of paratungstate and/or ammonium metatungstate, ammonium molybdate and nickel nitrate, reflow for 3 hours, aging, drying and calcination.

The low resistance to hydrothermal and coke deactivation of commercial hydrocarbon steam reforming catalysts leads to a reduction in the campaign time of the hydrogen and syngas generation units, generating an increase in CAPEX and more frequent production shutdowns.

In order to increase the campaign time of the hydrogen generation units, and thus reduce the cost of producing hydrogen and syngas, the present invention proposes a catalyst based on nickel, molybdenum and tungsten to steam reforming hydrocarbon streams (natural gas, refinery gas, propane, butane or naphtha, or mixtures thereof) for the production of hydrogen and/or syngas that has high resistance to deactivation by carbon deposition (coke). According to the present invention, the catalyst for the reforming process has NiMoW as its active phase, in bulk form and/or supported on an alumina oxide and other high surface area oxide supports, and may also contain other promoters. The present invention teaches the production of a catalyst whose active phase of NiMoW has high activity for the reaction of steam reforming of hydrocarbons, being nickel the main responsible for the decomposition of methane in H₂ and C(s) and the other metals having an action synergistic under the activity and resistance to coke formation of the catalyst.

According to the present invention, the catalyst is especially suitable for use in industrial units of large capacity for the production of hydrogen or syngas by the steam reforming process, and can also be used in the entire catalytic bed or in upper half of the reactors, or preferably in the region of 30% superior of the reactors, for presenting high resistance to deactivation by coke, which increases the campaign time and minimizes the production costs of syngas and/or hydrogen.

The invention also presents additional economic gains, as it does not replace nickel with noble metals (keeps a low cost of catalyst production), allows operation at low steam/carbon ratios and presents greater resistance to the deactivation process by coke formation, thus contributing to the extension of the campaign time of the hydrogen and syngas generation units.

Furthermore, the greater resistance to deactivation of the catalyst of the present invention reduces the frequency of inventory exchange operations which involve a greater operational risk. Consequently, there is a lower generation of solid waste (heavy metals) and lower costs related to the disposal of spent catalyst.

Another additional advantage of the catalyst of the present invention is that the formation of active phases such as Mo₂C and WC carbides allows the use of natural gas with high concentrations of CO₂ (range up to 70%), such as natural gas from pre-salt and other hydrocarbon streams containing high levels of CO₂, as steam reforming charge, using smaller amounts of water vapor in relation to the conventionally used ones. Greater resistance to deactivation by sulfur poisoning is also expected.

### BRIEF DESCRIPTION OF THE INVENTION

The present invention aims at enabling a hydrocarbon steam reforming catalyst (natural gas, refinery gas, propane, butane or naphtha, or mixtures thereof) for the production of hydrogen and/or syngas that has high resistance to deactivation by the deposition of carbon (coke). This catalyst also allows working with lower vapor/carbon ratios than traditional catalysts, without undergoing deactivation, and/or with streams rich in CO₂ (up to 70%). The catalyst for the steam reforming process is based on NiMoW, in bulk form and/or supported on an alumina oxide and other oxide supports of high surface area. Thus, the present invention advantageously presents economic gains, as it does not replace nickel with noble metals, allows operating with lower steam/carbon ratios and presents greater resistance to the deactivation process by coke formation than catalysts based only on nickel, according to the state of the art, which minimizes the production costs of syngas and/or hydrogen.

### BRIEF DESCRIPTION OF DRAWINGS

The present invention will be described in more detail below, with reference to the attached figures which, in a non-limiting way of the inventive scope, represent examples of embodiment thereof.

FIG. 1 represents a graph of conversion as a function of time for the steam reforming reaction of methane at a temperature of 850° C. and 20 bar (2 MPa). The activity of the catalysts was initially measured using a vapor/carbon ratio of 3 and a GHSV of 36000 h⁻¹ (baseline). During the deactivation step, the vapor/carbon ratio was reduced to 1.0 and the other reaction conditions were maintained;

FIG. 2 illustrates the XRD result of Examples 1 and 2;

FIG. 3 illustrates Scanning Electron Microscopy (SEM) micrographs—of the NiMoW catalyst (calcined at 300° C.)—magnifications of 2000, 10000 and 20000 times, respectively.

### DETAILED DESCRIPTION OF THE INVENTION

So that they can be better understood and evaluated, both the NiMoW trimetallic catalyst, with high resistance to deactivation by coke, for use in hydrogen production processes and/or syngas generation, and its production process and the process using said catalyst to produce hydrogen and/or syngas by steam reforming of hydrocarbons, will now be described in detail.

The present invention concerns a catalyst used in the process of reforming hydrocarbons, in the presence of water vapor and absence of oxygen, for the production of hydrogen and/or syngas, characterized in that the hydrocarbon stream is natural gas, refinery gas, propane, butane or naphtha, or mixtures thereof, particularly suitable for working with low vapor/carbon ratios and having a low tendency to deactivate by carbon deposition.

The present invention addresses to the preparation of a trimetallic NiMoW catalyst with a surface area between 20 and 150 m²/g. The ammonia precursor formed can also be supported on a refractory support belonging, for example, to the group of aluminas, especially that of “alpha” and “theta-aluminas”, to calcium aluminates, or magnesium aluminates, to zirconium oxides, lanthanum or cerium, to hexa-aluminates, titania or even a mixture of these, in any proportions, which may additionally contain alkali metals, preferably potassium, in contents between 0.2% and 15%, preferably between 0.5% and 6% w/w (expressed as K₂O). The surface area of the refractory support must be greater than 15 m²/g, more preferably between 20 m²/g and 100 m²/g. The particles of the refractory support and/or the oxide catalyst in its bulk form can be in the most varied forms, which are considered suitable for industrial use in the steam reforming process, which are selected among the spherical, cylindrical with a hole central (Rashing rings) and cylindrical with several holes, of these, preferably those with 4, 6, 7 or 10 holes, and the cylinder surface can also be wavy. The support and/or bulk catalyst particles are preferably in the range of 13 mm to 20 mm in diameter and 10 mm to 20 mm in height, with the smallest wall thickness between 2 mm and 8 mm, preferably between 3 mm and 6 mm.

The supported bulk trimetallic NiMoW catalyst is prepared via coprecipitation in ammoniacal medium (NH₄OH) of a mixture of paratungstate and/or ammonium metatungstate, ammonium molybdate and nickel nitrate, reflow for 3 hours, aging, drying and calcination.

More specifically, the process of preparing the catalyst based on a trimetallic oxide of NiMoW, in bulk or supported form, follows the following steps:
1) preparing a solution, preferably an aqueous one, of a soluble salt of tungsten, preferably in the form of paratungstate and/or metatungstate in an ammoniacal medium;
2) preparing a solution, preferably an aqueous one, containing nickel and molybdenum salts, preferably within the group of nitrates, acetates, carbonates and ammoniacal compounds and/or complexes;
3) mixing both solutions and resolubilize the formed precipitate with NH₄OH solution; 4) reflowing the solution for a period between 2 to 10 hours until the pH reaches values between 5 and 8, and wait for the slow formation and growth of the NiMoW—NH₄ precipitate in suspension, under stirring, for 5 to 24 hours at room temperature.
5) drying the NiMoW—NH₄ precipitate at temperatures between 80 and 120° C., for 1 to 24 hours, and calcinate it at temperatures between 200 and 650° C. for 1 to 8 hours, preferably between 200 and 350° C.
6) the impregnation of the trimetallic precursor, formed in step 3, on the inorganic oxide support, preferably alumina or calcium or magnesium aluminates or a mixture of these, can be carried out by using the pore volume techniques (wet spot), by the method of excess solution, precipitation, among others.
7) alternatively, the steps for impregnating the trimetallic precursor onto the inorganic support and subsequent drying and calcination can be repeated until the desired content of the oxide on the inorganic support is obtained. The percentages of the trimetallic precursor on the inorganic support can vary between 5% and 35% (w/w), preferably between 12% and 20% (w/w).
8) alternatively, the calcination of the catalyst (step 5) can be replaced by the direct reduction in flow of a reducing agent, selected from hydrogen, formaldehyde or methanol, under temperature conditions between 300 and 800° C., for 1 to 24 hours, followed by cooling by air flow, at temperatures between 20 and 60° C., for 1 to 5 hours, in order to prevent the catalyst from having a pyrophoric character when handled.

Additionally, compounds for pH control, solubility increase or to control the precipitation of solution components can be included as additives in the generated aqueous solutions. Non-limiting examples of these compounds are nitric acid, sulfuric acid, phosphoric acid, ammonium hydroxide, ammonia carbonate, hydrogen peroxide (H₂O₂), methanol, ethanol, sugars, etc. or combinations of these compounds.

The catalyst thus prepared needs to be activated, before industrial use, by reducing the nickel oxide phases to metallic nickel. Activation is preferably carried out “in-situ” in the industrial unit during the start-up procedure of the reformer, through the passage of a reducing agent, selected from natural gas, hydrogen, ammonia or methanol, in the presence of steam, at temperatures that vary between 400° C. and 550° C., at the top of the reactors, and from 750° C. to 850° C., at the exit of the same. The pressure during the activation step can be chosen, between 1 kgf/cm² (98.1 kPa) up to the maximum design pressure of the unit. The duration of the reduction step is from 1 to 15 hours, preferably from 2 to 6 hours, its end being indicated by the wall temperature of the tubes, or by the methane content in the reactor effluent, in the case of using the mixture of natural gas and steam in the activation step, in accordance with conventionally established industrial practice. The “in situ” activation step of the catalyst is carried out as follows:
a) heat the reformer containing the catalyst, with or without nitrogen flow, to temperatures around 50° C. above the dew point of the steam at the pressure chosen to carry out the activation process and from this moment on, introduce water steam into the reactor;
b) start the activation procedure by passing a reducing agent, which can be natural gas, hydrogen, ammonia or methanol, together with water vapor, through the tubes of the reformers, while heating the primary reformer, so that the process gas temperatures at the inlet of the tubes are between 400° C. and 550° C. and the outlet temperatures between 750° C. and 850° C., at pressures ranging from 1 kgf/cm² (98.1 kPa) to the maximum design pressure of the unit, typically of maximum 40 kgf/cm² (3.923 MPa);
c) maintain the operation for a period of 1 to 15 hours, preferably from 2 to 6 hours, or until the methane content in the reactor effluent gases stabilizes at a minimum level, indicative of the end of the activation process;
d) introduce the hydrocarbon feed and adjust the operating conditions (steam/charge ratio; recycle/charge hydrogen ratio; reformer inlet and outlet temperature and pressure) in order to initiate the hydrogen production process.

The catalysts thus prepared can be used in the production of hydrogen and/or syngas by hydrocarbon steam reforming processes, at pressures ranging from 1 kgf/cm² (98.1 kPa) to 50 kgf/cm² (4.903 MPa), at temperatures from 400° C. to 850° C., which processes are characterized by the presence of a hydrocarbon and steam reaction step for the production of syngas (CO; CO₂, H₂ and methane).

The hydrocarbons suitable for this purpose are natural gas, refinery gas; liquefied petroleum gas (LPG), propane, butane or naphtha, or a mixture thereof. Typically, the stationary operating conditions of the hydrogen and/or syngas production period comprise:
1. Inlet temperature of the tubular reactors measured in the process gas of the primary reformer between 400° C. and 600° C.
2. outlet temperature of the tubular reactors measured in the process gas of the primary reformer between 700° C. and 900° C., preferably between 750° C. and 850° C.
3. outlet pressure of the tubular reactors of the primary reformer between 1 kgf/cm² (98.1 kPa) and 50 kgf/cm² (4.903 MPa), preferably between 10 kgf/cm² (0.981 MPa) and 30 kgf/cm² (2.942 MPa).
4. vapor/carbon ratio (mol/mol) between 1.5 and 5.0, preferably between 2.5 and 3.5, when using a charge consisting of natural gas, propane, butane and LPG.
5. vapor/carbon ratio (mol/mol) between 2.5 and 6.0, preferably between 2.6 and 4.0, when using the hydrocarbon charge containing naphtha.

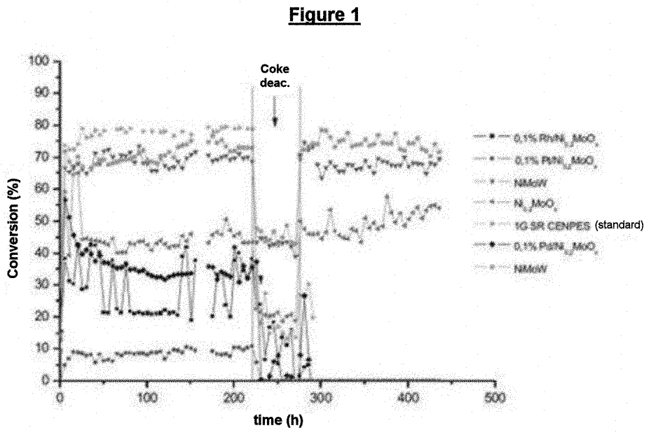

FIG. 1 shows a graph of methane conversion as a function of time, for the methane steam reforming reaction, at a temperature of 850° C. and 20 bar (2 MPa), in order to compare the stability of the trimetallic NiMoW catalyst in relation to catalyst formulations traditionally found in the literature and in relation to a commercial catalyst (Benchmark). The activity of the various catalysts tested was initially measured using a vapor/carbon ratio of 3 and a GHSV of 36000 h⁻¹ (baseline). In the deactivation step, the vapor/carbon ratio was reduced to 1.0 and the other reaction conditions were maintained. During the deactivation step, an increase in the pressure drop of the reactors containing NiMo oxide promoted with 0.1% of Rh, Pt and Pd was observed. The commercial reference catalyst (1G SR CENPES—Benchmark) also showed pressure drop. The high pressure drops observed in the reactor beds containing the above catalysts resulted in the interruption of these runs. The trimetallic NiMoW catalyst (tested in duplicate in bulk form) showed greater resistance to the coke deactivation process and showed a rapid recovery of activity when the steam/carbon ratio was returned to baseline. The bimetallic NiMo catalyst also showed a good recovery of activity with increasing vapor/carbon ratio.

### EXAMPLES

The following examples illustrate the high resistance to coke deactivation of the catalyst of the present invention, without, however, being considered as limiting its content.

### Example 1

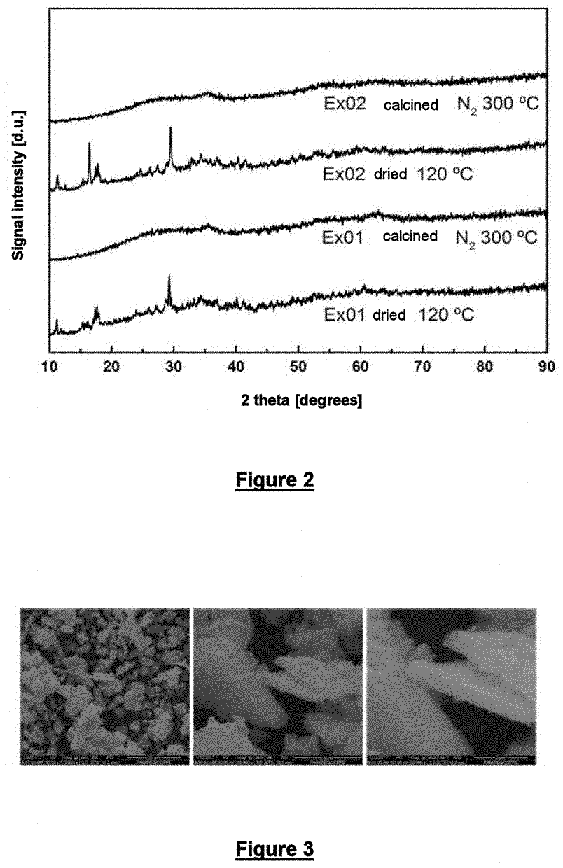

This example illustrates the preparation of a bulk based NiMoW trimetallic catalyst. The tungsten-containing solution (solution A) was initially prepared in a 500 mL beaker. 9.6753 g of ammonium paratungstate, 150 ml of NH₄OH (30 to 32% w/w) and 150 ml of H₂O were added. The suspension initially formed (pH=13) was kept under stirring at 80° C. for one hour, resulting in a clear solution (pH=9.8), resulting from the transformation of paratungstate into metatungstate. The solution containing nickel and molybdate (solution B) was prepared in a 100 mL beaker. 21.5122 g of nickel nitrate and 30 ml of H₂O were added. Kept under stirring for 5 minutes at room temperature (25° C.). Then 6.5432 g of ammonium molybdate was added. Keeping it under stirring for 5 min at room temperature (25° C.), resulting in a clear greenish solution with a pH close to 3.5. Solutions (A) and (B) were mixed in a single beaker. During mixing, the formation of a cyan-colored precipitate was observed. Soon after, 120 mL of NH₄OH were added, resolubilizing the precipitate initially formed, resulting in a clear methylene blue solution (pH=10.7). The mixture was then transferred to a two-neck flask (1 L). This was kept under stirring and heating, in a silicone bath, under reflow for approximately 3 hours, and its pH and temperatures were measured every 30 min. The pH values were measured at a temperature close to room temperature, periodically withdrawing 5 mL aliquots. After 3 hours, the reflow system was withdrawn. After approximately 1.5 hours of reaction, turbidity and color change (blue to cyan) were observed, resulting from the precipitation process. When the reaction mixture reached a pH close to 7 (pH=7.3), the heating was stopped. The mixture was kept under stirring for approximately 15 hours to promote the slow formation and growth of the suspended NiMoW—NH₄ precipitate. Filtration was carried out under vacuum and at room temperature, in a bunker funnel, using a quantitative filter paper. The filtrate (without washing) was dried in an oven at 120° C. for a period of approximately 24 hours, obtaining at the end of the process a mass of 14.4 g of NiMoW—NH₄ precursor. FIG. 2 shows the result of the characterization of the crystalline phases present in the precursor (Example 01) by X-ray diffractometry (XRD). The chemical composition was obtained by X-ray fluorescence (XRF), with a molar ratio Ni/(Mo+W) of 2.6 and a molar ratio Mo/W of 0.6 being observed. This precursor, when dried at 120° C. and then calcined at 300° C., presented a BET area of 65 m²/g and an average pore diameter of 25 A. The analysis of the precursor calcined at 300° C. by X-ray diffractometry showed that NiMoW has low crystallinity (microcrystalline or nearly amorphous material).

The presence of segregated phases of metal oxides (NiO, MoO₃ and WO₃) was also not observed. The Scanning Electron Microscopy (SEM) results of the sample calcined at 300° C., shown in FIG. 3, show that the bulk catalyst is formed by plates (lamellae), which are presented in regular (rectangular) and irregular (rounded) geometric shapes. having different particle sizes.

### Example 2

This example in accordance with the present invention illustrates the preparation of a bulk based NiMoW trimetallic catalyst. The tungsten-containing solution (solution A) was initially prepared in a 500 mL beaker. 4.80 g of ammonium paratungstate, 75 ml of NH₄OH (30 to 32% m/m) and 75 ml of H₂O were added. The initially formed suspension (pH=13) was kept under stirring, at a temperature between 80 and 90° C., for two hours, resulting in a clear solution (pH=9.8), resulting from the transformation of paratungstate into metatungstate. The solution containing nickel and molybdate (solution B) was prepared in a 100 mL beaker. 10.80 g of nickel nitrate and 15 ml of H₂O were added. Kept under stirring for 5 min at room temperature (25° C.). Then 3.3 g of ammonium molybdate were added. Keeping it under stirring for 5 minutes at room temperature (25° C.), resulting in a clear greenish solution with a pH close to 3.5. Solutions (A) and (B) were mixed in a single beaker. During mixing, the formation of a cyan-colored precipitate was observed. Soon after, 50 mL of NH₄OH was added, resolubilizing the initially formed precipitate, resulting in a clear methylene blue solution (pH=10.0). The mixture was then transferred to a two-neck flask (1 L). This was kept under stirring and heating, in a silicone bath, under reflow for approximately 3 hours, and its pH and temperatures were measured every 30 min. The pH values were measured at a temperature close to room temperature, periodically withdrawing 5 mL aliquots. After 3 hours, the reflow system was withdrawn. After approximately 1.5 hours of reaction, turbidity and color change (blue to cyan) were observed, resulting from the precipitation process. When the reaction mixture reached pH=7, the heating was stopped. The mixture was stirred for approximately 15 hours to promote the slow formation and growth of the suspended NiMoW—NH₄ precipitate. Filtration was carried out at room temperature and under vacuum, in a bunker funnel, using a quantitative filter paper. The filtrate (without washing) was dried in an oven at 120° C. for a period of approximately 24 hours, obtaining at the end of the process a mass of 9 g of NiMoW—NH₄ precursor. FIG. 2 shows the result of the characterization of the crystalline phases present in the precursor (Example 01) by X-ray diffractometry (XRD). The chemical composition was obtained by X-ray fluorescence (FRX), with a Ni/(Mo+W) molar ratio of 2.0 and a Mo/W molar ratio of 1.1. In the precursors of Examples 1 and 2, NiMoW—NH₄, dried at 120° C., there is the presence of thermally unstable phases (oxy-ammoniacal hydroxides of Mo and W) that decompose during calcination at 300° C., in flow of N₂.

### Example 3

This example in accordance with the present invention illustrates the preparation of a trimetallic NiMoW catalyst in a similar manner to Example 2 up to the point where solutions (A) and (B) were mixed in a single beaker, resolubilized with 50 mL of NH₄OH and transferred to a 1-liter double-necked flask. At this point, 20 mL of ethanol were added as a co-solvent and the mixture was kept under stirring and heating, in a silicone bath, under reflow for approximately 3 hours, with its pH and temperatures measured every 30 minutes. The pH values were measured at a temperature close to room temperature, periodically withdrawing 5 mL aliquots. After 3 hours, the reflow system was withdrawn. After approximately 1.5 hours of reaction, turbidity and color change (blue to cyan) were observed, resulting from the precipitation process. When the reaction mixture reached pH=7, the heating was stopped. The mixture was stirred for approximately 15 hours to promote the slow formation and growth of the suspended NiMoW—NH₄ precipitate. At room temperature, filtration was carried out under vacuum, in a bunker funnel, using a quantitative filter paper. The filtrate (without washing) was dried in an oven at 120° C. for a period of approximately 24 hours, obtaining at the end of the process a mass of 9 g of NiMoW—NH₄ precursor.

### Example 4

This example in accordance with the present invention illustrates the preparation of a catalyst based on NiMoW trimetallic oxide in a similar manner to Example 2 up to the point where solutions (A) and (B) were mixed in a single beaker, 50 mL of NH₄OH were resolubilized and transferred to a 1-liter double-necked flask. At this point, 100 grams of theta-alumina (SPH 508F from Axens, with a pore volume of 0.7 cm³/g in the shape of 3 to 4 mm diameter spheres) were added to the flask. The entire mixture was kept under stirring and heating, in a silicone bath, under reflow for approximately 3 hours, and its pH and temperatures were measured every 30 minutes. The pH values were measured at a temperature close to room temperature, periodically withdrawing 5 mL aliquots. After 3 hours, the reflow system was withdrawn. After approximately 1.5 hours of reaction, turbidity and color change (blue to cyan) were observed, resulting from the precipitation process. When the reaction mixture reached pH=7, the heating was stopped. The mixture was stirred for approximately 15 hours to promote the slow formation and growth of the suspended NiMoW—NH₄ precipitate. At room temperature, filtration was carried out under vacuum, in a bunker funnel, using a quantitative filter paper. The filtrate (without washing) was dried in an oven at 120° C. for a period of approximately 24 hours, obtaining at the end of the process the NiMoW—NH₄ precursor impregnated on theta-alumina.

### Example 5

This example illustrates that the catalyst of the present invention is particularly suitable for industrial use and can be activated under operating conditions or even at low temperatures. The tests were conducted in a multipurpose combinatorial catalysis unit, capable of evaluating up to 16 catalysts at the same time, under the same process conditions and/or varying the conditions of each microreactor independently. The tests were carried out with 700 mg of the catalyst from Example 2 in the form of a powder with a granulometry less than or equal to 140 mesh. In the catalytic test, Ni_{0.2}MoOₓ bimetallic oxide and promoted Ni_{0.2}MoOₓ bimetallic oxide, respectively, with 0.1% of Rh, Pt and Pd were also evaluated. All samples were prepared in the laboratory in the same granulometry. By way of comparison of the advantage of this invention, 700 mg of a commercial nickel-based catalyst with high resistance to coke deactivation (Benchmark) was also evaluated. The activation reaction of bimetallic and trimetallic oxides was carried out with hydrogen at 400° C., with a heating rate of 1.5° C./min, remaining in this condition for 4 h. At the end of this stage, the temperature was increased to 500° C. at a rate of 1.5° C./min. The commercial catalyst was activated with hydrogen by using a heating rate of 1.5° C./min to a temperature of 205° C. At this temperature, steam was introduced until reaching a steam:hydrogen ratio in the range of 6 to 10 mol/mol and the temperature was raised to 750° C. at a rate of 1.5° C./min, maintaining the steam and hydrogen flow rate. The reactor remained in this condition for six hours to complete the reduction. The conditions established for the catalytic tests were: pressure of 20 bar (2 MPa) g, temperature of 850° C., steam/CH₄ ratio of 3 mol/mol, H₂/CH₄ ratio of 0.05 mol/mol and GHSV of 36000 h⁻¹. Effluent gases from the reactors were analyzed by gas chromatography using a thermal conductivity detector (TCD). Activity was measured by the degree of methane conversion. The deactivation step by coking was carried out by reducing the steam/carbon ratio from 3 mol/mol to 1 mol/mol and by keeping the other reaction conditions constant. After the deactivation step, the initial test condition was re-established by increasing the steam/carbon ratio. FIG. 1 shows the graph of methane conversion as a function of time for the methane steam reforming reaction, at a temperature of 850° C. and pressure of 20 bar (2 MPa), for the various catalysts. During the deactivation step, a great increase in the pressure drop of the reactors containing NiMo oxide promoted with 0.1% of Rh, Pt, and Pd was observed, generating flow reduction and clogging of the system. The commercial reference catalyst also showed a high pressure drop, making it impossible to continue this run. The trimetallic NiMoW catalyst (tested in duplicate in bulk form) showed greater resistance to deactivation by coke and showed a rapid recovery of activity when the initial test condition was restored (steam/carbon ratio 3). The non-promoted NiMo oxide bimetallic catalyst also showed a good recovery of activity with increasing vapor/carbon ratio.

Example 5 illustrates that the catalyst of the present invention has a resistance to deactivation by coke superior to those based on the prior art, returning to a high level of conversion, even after being subjected to severe coking conditions for long periods.

The results clearly demonstrate that the present invention advantageously achieves the desired objectives listed above. It should be clear, however, that such examples are merely illustrative, without constituting a limitation to the inventive concept described herein. Those usually versed in the art will be able to envision and practice variations, modifications, alterations, adaptations and equivalents that are appropriate and compatible with the matter in question, without, however, departing from the scope of the spirit and scope of the present invention.

In short, according to the present invention, the technological solution to reduce the deactivation of the catalyst by deposition of coke, with the consequent reduction of the pressure drop and increase of the campaign time of the units of generation of H₂ and syngas, takes place through the catalyst based on nickel, molybdenum and tungsten. The catalyst described is especially suitable for use in industrial units with large capacity for the production of hydrogen or syngas by the steam reforming process, and can be used in the entire catalytic bed or in the upper half of the reactors, or preferably in the region of upper 30% of the reactors, due to its high resistance to deactivation by coke. Thus, the catalyst of the present invention advantageously presents economic gains, for not using noble metals in its composition and for reducing the energy consumption of the process, through the operation of the units with lower vapor/carbon molar ratios, which is possible due to its higher resistance to coke formation when compared to nickel-based catalysts of the state of the art. These economic advantages imply the reduction of production costs of syngas and/or hydrogen.

1- A CATALYST FOR GENERATION OF HYDROGEN AND/OR SYNGAS THROUGH THE STEAM REFORMING PROCESS OF HYDROCARBONS, characterized in that:
a) the active phase is formed by nickel, molybdenum and tungsten (NiMoW), where the atomic ratio of Ni/(Mo+W) is between 6:1 and 5:1 and the atomic ratio of Mo/W between 2:1 and 1:1;
b) the surface area is in the range between 20 and 150 m²/g;
c) it presents itself in bulk form or uses refractory oxide supports, with a surface area greater than 15 m²/g, in the proportion of 95% to 65% by weight in relation to the total composition;
d) optionally, it contains an alkali metal in a concentration ranging from 0.2% to 15% by weight;
e) optionally, it contains a promoter noble metal, selected from a group comprising Pt, Pd, Ru and Rh, and by combinations thereof in any proportions, in a concentration in the range of 0.01% to 1% by weight, calculated as a metallic element.

2- THE CATALYST according to claim 1, characterized in that the refractory oxide support is selected from a group comprising alumina, calcium and magnesium aluminates, zirconium oxides, titania, lanthanum and cerium oxides, hexa-aluminates, and mixtures thereof in any proportions.

3- THE CATALYST according to claim 1, characterized in that the active phase has an atomic ratio of Ni/(Mo+W) between 4:1 and 3:1.2 and atomic ratio of Mo/W between 1.2:1 and 0.8:1.

4- THE CATALYST according to claim 1, characterized in that the active phase has an atomic ratio of Ni/(Mo+W) between 3:1 and 0.5:1 and atomic ratio of Mo/W between 0.8:1 and 0.05:1.

5- THE CATALYST according to claim 1, characterized in that the final catalyst composition optionally contains from 95% to 65% by weight of refractory oxide supports, with an area between 20 m²/g and 100 m²/g;

6- THE CATALYST according to claim 1, characterized in that the alkali metal is preferably potassium, in a concentration ranging from 1% to 7% by weight, calculated as K₂O.

7- THE CATALYST according to claim 1, characterized in that the promoter noble metal is preferably platinum.

8- THE CATALYST according to claim 1, characterized in that the promoter noble metal is present in concentrations ranging from 0.01% to 0.2% by weight, calculated as a metallic element.

9- A METHOD FOR OBTAINING THE CATALYST described in claim 1, characterized in that it comprises the following steps:
a) preparing a solution, preferably an aqueous one, of a soluble salt of tungsten, chosen in the form of paratungstate and/or metatungstate in an ammoniacal medium;
b) preparing a solution, preferably an aqueous one, containing nickel and molybdenum salts, chosen from the group of nitrates, acetates, carbonates, ammoniacal salts and ammoniacal complexes;
c) mixing the solutions from step a) and b) and resolubilizing the precipitate formed with NH₄OH solution;
d) reflowing the solution for a period between 2 to 10 hours, until reaching a pH in the range between 5 and 8 and keeping the solution under stirring, for 1 to 24 hours, at room temperature;
e) drying the NiMoW—NH₄ precipitate, at a temperature in the range between 80 and 120° C., for 1 to 24 hours and calcining it at a temperature in the range between 200 and 650° C., for 1 to 24 hours;
f) optionally, impregnating the trimetallic oxide on an inorganic oxide support, selected from alumina, calcium or magnesium aluminates, rare earth hexa-aluminates, titania or a mixture thereof, from step c);
g) alternatively, repeating step f) until the desired content of the oxide on the inorganic support is reached;
h) alternatively, co-solvents and other chemical compounds can be used in the aqueous solutions generated in steps a), b), and c) for better pH control, increased solubility and/or reduced solubility.

10- THE METHOD FOR OBTAINING THE CATALYST according to claim 9, characterized in that the calcination (step e)) is carried out, preferably, at temperatures in the range between 200 and 350° C.

11- THE METHOD FOR OBTAINING THE CATALYST according to claim 9, characterized in that the content of trimetallic oxide in the inorganic support varies between 5% and 35% (w/w), preferably between 12% and 20% (w/w).

12- THE METHOD FOR OBTAINING THE CATALYST according to claim 9, characterized in that the co-solvent of step h) can be nitric acid, sulfuric acid, phosphoric acid, ammonium hydroxide, ammonium carbonate, methanol, ethanol, acetone, hydrogen peroxide (H₂O₂), sugars or combinations of these compounds.

13- THE METHOD FOR OBTAINING THE CATALYST according to claim 9, characterized in that the calcination can be replaced by a direct reduction in flow of a reducing agent.

14- THE METHOD FOR OBTAINING THE CATALYST according to claim 9, characterized in that the reducing agent is selected from hydrogen, formaldehyde, methanol or natural gas.

15- A PROCESS FOR PRODUCTION OF HYDROGEN OR SYNGAS BY STEAM REFORMING, characterized in that there is:
a) charging the reformer with the catalyst as defined in claims 1 to 8;
b) “in situ” activating the catalysts in the presence of water vapor and a reducing agent selected from hydrogen, natural gas, ammonia and methanol;
c) introducing the hydrocarbon charge, at the end of the activation, to start the production of hydrogen and/or syngas.

16- THE PROCESS FOR PRODUCTION OF HYDROGEN OR SYNGAS BY STEAM REFORMING according to claim 15, characterized in that the upper third of the reformer tubes is preferably charged with the catalyst.

17- THE PROCESS FOR PRODUCTION OF HYDROGEN OR SYNGAS BY STEAM REFORMING according to claim 15, characterized in that the hydrocarbon charge can be selected from a group comprising natural gas, refinery gas, liquefied petroleum gas, propane, butane, naphtha, and mixtures thereof in any proportion.

18- THE PROCESS FOR PRODUCTION OF HYDROGEN OR SYNGAS BY STEAM REFORMING according to claim 15, characterized in that it operates with steam/carbon ratios (mol/mol) at the inlet of the reformer tubes in the range between 0.5 and 6.0.

19- THE PROCESS FOR PRODUCTION OF HYDROGEN OR SYNGAS BY STEAM REFORMING according to claim 15, characterized in that is uses steam/carbon ratios lower than 1.5 and hydrocarbon charges containing C02 concentrations of up to 70%.
